(19) United States
(12) Patent Application Publication
(10) Pub. No.: US 2026/0180302 A1
(43) Pub. Date: Jun. 25, 2026

(54) BUS BAR UNIT AND BRUSHLESS MOTOR

(71) Applicant: MABUCHI MOTOR CO., LTD., Chiba (JP)

(72) Inventor: Kazuya INOZUME, Chiba (JP)

(21) Appl. No.: 19/146,927

(22) PCT Filed: Dec. 23, 2024
(86) PCT No.: PCT/JP2024/045420

§ 371 Date: Jul. 10, 2025

(51) Int. Cl. H02G 5/04; H02G 5/00; H02K 1/16; H02K 1/274; H02K 3/12; H02K 11/00

(52) U.S. Cl. CPC H02G 5/04; H02G 5/005; H02K 1/165; H02K 1/274; H02K 3/12; H02K 11/0094

(57) ABSTRACT

A bus bar unit includes a bus bar having an approximately arc-shaped base plate portion; and a non-conductive holder configured to cover the base plate portion. The holder includes: an exposure portion that exposes a part of the base plate portion; and a guide portion that guides a conductive wire to be connected to the part to the exposure portion to be bent. Alternatively, a bus bar unit may include a bus bar having a plate-shaped base plate portion; and a resin holder configured to cover the base plate portion. The holder includes: an exposure portion that exposes only a part of the base plate portion in a first direction; and a guide portion that guides a conductive wire to be joined to the part from a second direction to the first direction.

### TECHNICAL FIELD

The present invention relates to a bus bar unit and a brushless motor including the bus bar unit.

### BACKGROUND ART

A motor is conventionally known in which a conductive wire forming a coil integrated into the motor is joined by soldering to a conductive bus bar (for example, Patent Literature 1).

### CITATION LIST

### Patent Literature

Patent Literature 1: JP-A-2024-123482

### DISCLOSURE OF THE INVENTION

### Problems to be Solved by the Invention

Incidentally, in such a motor including a stator as disclosed in Patent Literature 1, soldering for joining a conductive wire to a bus bar may be manually performed; therefore, there is room for improvement in that the number of man-hours related to joining increases. Note that the above problem is a problem that may arise when a conductive wire is joined to a bus bar, and is not limited to a case where the conductive wire is a conductive wire (winding) of a coil, and is not limited to a case where a device provided with the bus bar is a motor or a stator.

The present invention has been devised in view of such a problem, and one of objects thereof is to provide a bus bar unit and brushless motor that can reduce the number of man-hours related to joining of a conductive wire to a bus bar. Note that objects of the present invention are not limited to this object, but also include another object of exerting operations and effects that can be derived from configurations presented in DESCRIPTION OF PREFERRED EMBODIMENTS described below, the operations and effects being unobtainable by the known technology.

### Solutions to the Problems

A bus bar unit and brushless motor of the disclosure can be achieved as aspects (application examples) disclosed below, and solves at least a part of the above problem. Note that Aspect 3 is an aspect that can be additionally selected for another bus bar unit of Aspect 2 as appropriate, and is an aspect that can be omitted. In other words, Aspect 3 does not disclose an aspect and configuration that are essential to the other bus bar unit of the present invention.

Aspect 1. A bus bar unit of the disclosure includes: a bus bar having an approximately arc-shaped base plate portion; and a non-conductive holder configured to cover the base plate portion, in which the holder includes: an exposure portion that exposes a part of the base plate portion; and a guide portion that guides a conductive wire to be joined to the part to the exposure portion to be bent.

Aspect 2. Another bus bar unit of the disclosure includes: a conductive bus bar having a plate-shaped base plate portion; and a resin holder configured to cover the base plate portion. The holder includes: an exposure portion that exposes only a part of the base plate portion in a first direction of a thickness direction of the base plate portion; and a guide portion that is attached to the exposure portion and guides a conductive wire to be joined to the part from a second direction opposite to the first direction to the first direction.

Aspect 3. In an aspect including Aspect 2 above, it is preferable that the bus bar unit be applied to an inner rotor brushless motor including a ring-shaped stator and a rotor located on a radially inner side of the stator, and the conductive wire be a start wire of a winding forming a coil of the stator and be drawn out in a predetermined axial direction of an axial direction of the stator. Moreover, it is preferable for the bus bar unit that in a state where the first direction is aligned with the predetermined axial direction, the holder be mounted on the predetermined axial direction side of the stator, the guide portion be a through-hole that penetrates in the axial direction and through which the start wire is inserted, and the exposure portion be a notch that exposes the part of the base plate portion in the predetermined axial direction on the inner side or a radially outer side of the through-hole.

Aspect 4. A brushless motor of the disclosure includes: the bus bar unit including Aspect 3 above; the stator on which the bus bar unit is mounted; and the rotor configured to rotate integrally with a shaft on the inner side of the stator.

### Effects of the Invention

According to a bus bar unit and brushless motor of the disclosure, it is possible to reduce the number of man-hours related to joining of a conductive wire to a bus bar.

### BRIEF DESCRIPTION OF THE DRAWINGS

FIG. 1 is an exploded perspective view of a brushless motor to which a bus bar unit according to an embodiment is applied.

FIG. 2 is a perspective view of a stator included in the brushless motor of FIG. 1.

FIG. 3 is a diagram schematically illustrating a wiring method and a connection method of windings forming coils provided to the stator of FIG. 2.

FIG. 4 is a diagram for explaining characteristics of a start wire and end wire of a winding, and is a perspective view illustrating a part of a core unit of the stator and a winding wound around the part.

FIG. 5 is a perspective view of a first bus bar unit and the stator, which are included in the brushless motor of FIG. 1, as viewed in a first axial direction.

FIG. 6 is a perspective view of the first bus bar unit of FIG. 5 as viewed in a second axial direction.

FIG. 7 is a perspective view of a second bus bar unit and the stator, which are included in the brushless motor of FIG. 1, as viewed in the second axial direction.

FIG. 8 is a cross-sectional view on arrows X-X of the second bus bar unit of FIG. 7.

### DESCRIPTION OF PREFERRED EMBODIMENTS

A bus bar unit and a brushless motor as embodiments are described with reference to the drawings. The embodiments presented below are mere exemplifications, and there is no intention to preclude various modifications and application of a technology, which are not explicitly stated in the embodiments below. The configurations of the embodiments can be modified and carried out in various manners within the scope that does not depart from the purport of the configurations.

The bus bar unit includes: a bus bar having an approximately arc-shaped base plate portion; and a non-conductive holder configured to cover the base plate portion. The holder is provided with: an exposure portion that exposes a part of the base plate portion; and a guide portion that guides a conductive wire to be joined to the part to the exposure portion to be bent.

Alternatively, a bus bar unit includes: a conductive bus bar having a plate-shaped base plate portion; and a resin holder configured to cover the base plate portion. The holder is provided with: an exposure portion that exposes only a part of the base plate portion on one side (a first direction) in a thickness direction of the base plate portion; and a guide portion that guides a conductive wire to be joined to the part. The guide portion is attached to the exposure portion and guides the conductive wire from a second direction (the other side in the thickness direction) opposite to the first direction to the first direction.

The above configuration allows the conductive wire guided by the guide portion to be brought into contact with the part of the base plate portion and joined to the bus bar by spot welding, which contributes to a reduction in man-hours. The bus bar unit described in detail below is applied to a brushless motor as an example, but an application target of the above bus bar unit is not limited to a motor, and may be various electrical components such as a switchboard, a storage battery, and a generator.

### 1. Configuration

### 1-1. Overall Configuration

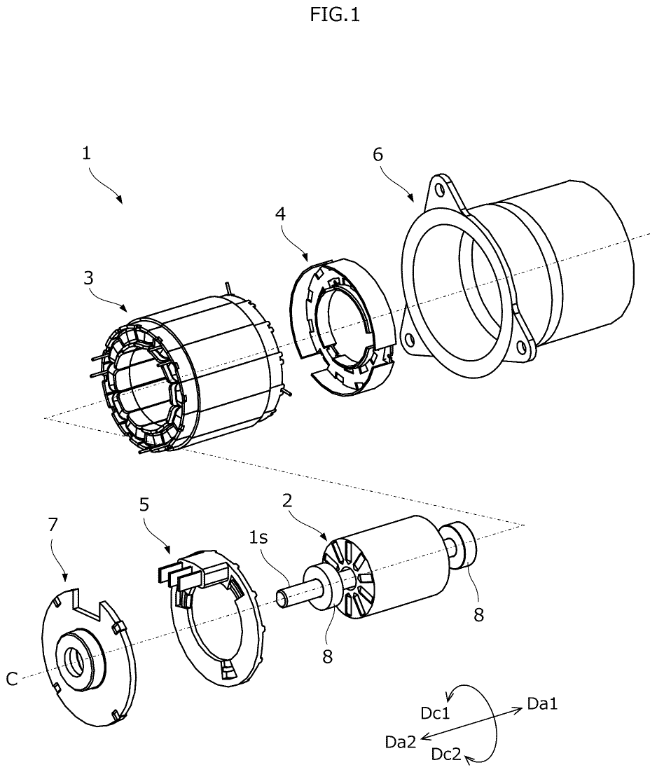

FIG. 1 is an exploded perspective view of a brushless motor 1 (hereinafter also referred to as the “motor 1”) to which a bus bar unit according to the embodiment is applied. The brushless motor 1 according to the embodiment is an inner rotor brushless motor, and includes a rotor 2 that rotates integrally with a shaft 1s, a stator 3, and bus bar units 4 and 5 as illustrated in FIG. 1. The motor 1 is configured by integrating the rotor 2, the stator 3, and the bus bar units 4 and 5 into a bottomed cylindrical housing 6. An end bell 7 as a lid member may be assembled to an opening side (the left side in the drawing) of the housing 6.

Hereinafter, an extension direction of the shaft 1s (a direction of an axis C of the shaft 1s) is referred to as the axial direction. In the axial direction, a direction in which the bottom portion of the housing 6 is located relative to the opening of the housing 6 (the right side in FIG. 1) is referred to as a first axial direction Da1, and a direction opposite to the first axial direction Da1 is referred to as a second axial direction Da2 (a predetermined axial direction). A direction orthogonal to the axial direction, the direction being away from the axis C and toward the axis C, is referred to as the radial direction. In the radial direction, a direction away from the axis C is referred to as the radially outer side (radially outward), and a direction toward the axis C is referred to as the radially inner side (radially inward). A direction orthogonal to the axial direction, the direction circling around the axis C, is referred to as the circumferential direction. In the circumferential direction, as viewed in the first axial direction Da1, a clockwise direction is referred to as a first circumferential direction Dc1, and a direction opposite to the first circumferential direction Dc1 (a counterclockwise direction) is referred to as a second circumferential direction Dc2.

As illustrated in FIG. 1, the motor 1 exemplified here includes two bus bar units 4 and 5 that are provided in such a manner as to sandwich the stator 3 in the axial direction. Hereinafter, the bus bar unit 4 located on the first axial direction Da1 side of the stator 3 is referred to as the first bus bar unit 4, and the bus bar unit 5 located on the second axial direction Da2 side of the stator 3 is referred to as the second bus bar unit 5. The first bus bar unit 4, the stator 3, and the second bus bar unit 5 are placed in this order from the first axial direction Da1 toward the second axial direction Da2, and are integrated into the housing 6. The rotor 2 and the shaft 1s are inserted through the stator 3 and the two bus bar units 4 and 5 on the radially inner side. The bus bar unit according to the embodiment is provided (applied) as the second bus bar unit 5.

### 1-2. Rotor

The rotor 2 includes, for example, a rotor core that rotates integrally with the shaft 1s, and a plurality of magnets embedded in the rotor core. The shaft 1s is a rotary shaft that supports the rotor 2, and also functions as an output shaft that extracts output (mechanical energy) of the motor 1 to the outside. The shaft 1s is rotatably supported by the bottom portion of the housing 6 and the end bell 7 via, for example, bearings 8 in two places sandwiching the rotor core in the axial direction.

### 1-3. Stator

The stator 3 is a ring-shaped component having, on the radially inner side, a space in which the rotor 2 is placed, and is placed concentrically with the axis C. Therefore, the above-mentioned axial direction, radial direction, and circumferential direction of the axis C also translate into the axial direction, radial direction, and circumferential direction of the stator 3 respectively. An external shape of the stator 3 of the embodiment is a circular ring (cylindrical) shape, but the shape of the stator 3 is not limited thereto.

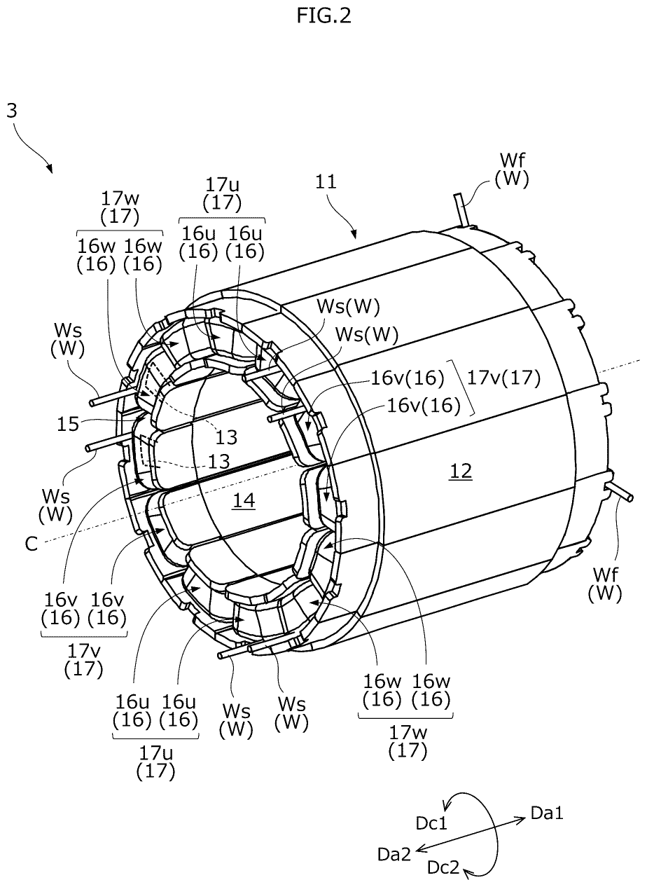

As illustrated in FIG. 2, the stator 3 includes an approximately cylindrical core unit 11 and a plurality of coils 16. The core unit 11 is provided as, for example, an insert-molded product obtained by molding a stator core with resin to be an insulator, and is fixed in the housing 6. The core unit 11 includes a cylindrical outer peripheral wall 12, a plurality of teeth 13 protruding radially inward from an inner peripheral surface of the outer peripheral wall 12, and circular arc-shaped inner peripheral walls 14 extending in the circumferential direction on the radially inner sides of their respective teeth 13. The plurality of teeth 13 is equally spaced apart from one another in the circumferential direction. Slots 15 as many as the teeth 13 are formed between the plurality of teeth 13. The coils 16 are formed by winding windings W around the plurality of teeth 13, and are provided as many as the teeth 13.

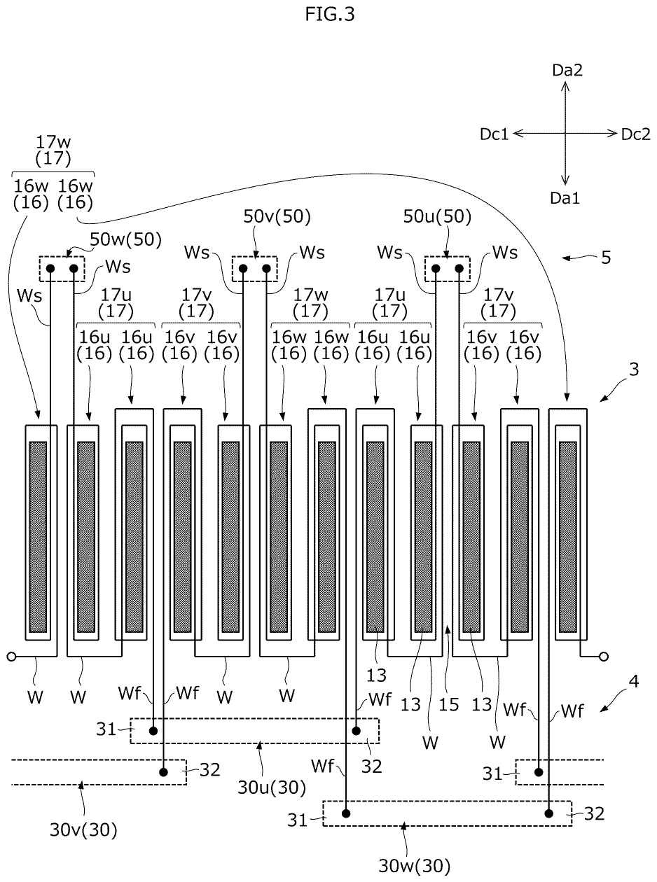

As illustrated in FIGS. 2 and 3, the stator 3 of the embodiment is provided with 12 teeth 13, 12 slots 15, and 12 coils 16. The stator 3 is provided with four phase-U coils 16u, four phase-V coils 16v, and four phase-W coils 16w as the 12 coils 16. Phase-U current is supplied to the phase-U coils 16u, phase-V current is supplied to the phase-V coils 16v, and phase-W current is supplied to the phase-W coils 16w.

Note that in FIG. 2, of the 12 teeth 13, only two teeth 13 adjacent to each other in the circumferential direction are illustrated with broken lines. Moreover, of the 12 slots 15, only one slot 15 formed between the two illustrated teeth 13 is assigned the reference sign. In FIG. 3, only parts of the 12 teeth 13 and the 12 slots 15 are assigned their respective reference signs.

In the stator 3, for example, as illustrated in FIG. 2, two pairs of the phase-U coils 16u, two pairs of the phase-V coils 16v, and two pairs of the phase-W coils 16w are provided side by side in the circumferential direction. In other words, two of the four phase-U coils 16u are provided adjacent to each other in the circumferential direction, and two phase-V coils 16v are provided adjacent to each other in the circumferential direction, adjacent to the second circumferential direction Dc2 side of the two phase-U coils 16u. Moreover, two phase-W coils 16w are provided adjacent to each other in the circumferential direction, adjacent to the second circumferential direction Dc2 side of the two phase-V coils 16v, and the remaining two of the four phase-U coils 16u are provided adjacent to each other in the circumferential direction, adjacent to the second circumferential direction Dc2 side of the two phase-W coils 16w. The remaining two phase-V coils 16v are provided adjacent to each other in the circumferential direction, adjacent to the second circumferential direction Dc2 side of the remaining two phase-U coils 16u, and the remaining two phase-W coils 16w are provided adjacent to each other in the circumferential direction, adjacent to the second circumferential direction Dc2 side of the remaining two phase-V coils 16v.

Each two in-phase coils 16 placed adjacent to each other is collectively referred to as a coil group 17. This means that the stator 3 including the 12 coils 16 includes two phase-U coil groups 17u, two phase-V coil groups 17v, and two phase-W coil groups 17w. Moreover, in terms of the above-mentioned placement of the coils 16, to put another way, the phase-U coil group 17u, the phase-V coil group 17v, and the phase-W coil group 17w are placed side by side in the circumferential direction, one by one in rotation in this order, until the stator 3 is provided with two coil groups 17 of each phase in such a manner as to face each other across the axis C.

In the embodiment, as illustrated in FIG. 3, each of the coil groups 17 is formed by one continuous winding W. In other words, the stator 3 is provided with six windings W, and each of the windings W is wound around two teeth 13 adjacent to each other in the circumferential direction to form each of the coil groups 17. More specifically, each of the windings W forming its respective coil group 17 is wound around one of the two teeth 13 adjacent to each other in the circumferential direction and then around the other of the two teeth 13 without being cut. As illustrated, each of the windings W forming its respective coil group 17 may be routed (wired) in such a manner that the winding direction of the one of the teeth 13 is opposite to the winding direction of the other of the teeth 13.

One of a start wire Ws and an end wire Wf of each of the windings W is drawn out in the first axial direction Da1, and the other is drawn out in the second axial direction Da2. In the embodiment, as illustrated in FIG. 3, the start wires Ws of the six windings W are all drawn out in the second axial direction Da2, and the end wires Wf of the six windings W are all drawn out in the first axial direction Da1. The six start wires Ws drawn out in the second axial direction Da2 are joined (connected) to bus bars 50, which are described below, of the second bus bar unit 5, and the six end wires Wf drawn out in the first axial direction Da1 are joined (connected) to bus bars 30, which are described below, of the first bus bar unit 4.

In terms of the six start wires Ws drawn out in the second axial direction Da2, the start wires Ws of the windings W forming the adjacent coil groups 17 may be drawn out from the same (common) slots 15. In the embodiment, two start wires Ws are drawn out from each of three slots 15 being every fourth slot located in the circumferential direction. Similarly, in terms of the six end wires Wf drawn out in the first axial direction Da1, the end wires Wf of the windings W forming the adjacent coil groups 17 may be drawn out from the same slots 15. In the embodiment, two end wires Wf are drawn out from each of three slots 15 being every fourth slot located in the circumferential direction. The start wire Ws and end wire Wf of each of the windings W may be drawn out from different slots 15 as illustrated in FIG. 3, or may be drawn out from the same slot 15.

Note that the start wire Ws referred to herein means a portion, at which a winding process starts, of each of the windings W (conductive wires) forming its respective coil group 17, and the end wire Wf means a portion, at which the winding process ends, of each of the windings W (the conductive wires) forming its respective coil group 17. Electricity supplied to each of the coil groups 17 may flow from the start wire Ws to the end wire Wf, or from the end wire Wf to the start wire Ws. Therefore, the start wire Ws and the end wire Wf are defined regardless of the flow direction of the electricity supplied to each of the coil groups 17.

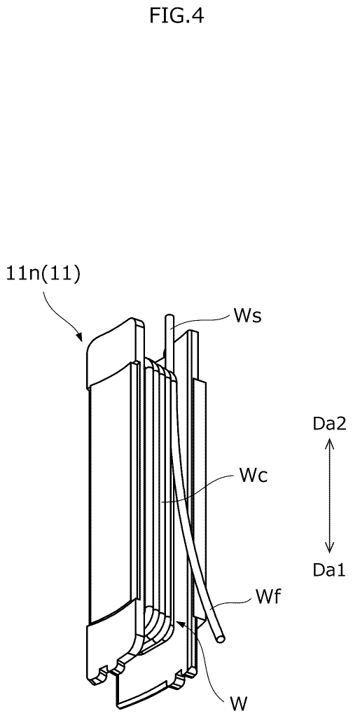

FIG. 4 is a perspective view illustrating a part of the core unit 11 as an example for explaining the characteristics of the start wire Ws and the end wire Wf of the winding W, and the winding W wound around the part. FIG. 4 illustrates only one of 12 split cores 11n obtained by dividing the core unit 11 into 12 pieces in the circumferential direction, as the part of the core unit 11. The core unit 11 may be configured by combining the split cores 11n divided equally in the circumferential direction in this manner.

Moreover, a description has been given, assuming that one coil group 17 including two in-phase coils 16 is formed by continuously winding one winding W around two adjacent teeth 13 in the stator 3 of the embodiment as described above. However, FIG. 4 illustrates a case where one winding W is wound around only one split core 11n (one tooth) to form one coil 16. In this manner, the stator 3 may be provided with as many windings W as the teeth 13.

As illustrated in FIG. 4, a connecting wire Wc that connects the start wire Ws and the end wire Wf is wound around the tooth; therefore, the start wire Ws of the winding W is restrained and fixed by the connecting wire Wc. The start wire Ws of each of the windings W forming its respective coil group 17 is fixed in this manner and therefore has a characteristic that the positions of the start wires Ws in the radial direction are less likely to vary (with little play) among the coil groups 17. On the other hand, the end wire Wf, which is a winding end portion of the winding W, is not restrained by the connecting wire Wc and therefore has a characteristic of being freely drawn radially inward or outward and in the first axial direction Da1. From these characteristics, to put another way, the start wire Ws is a fixed end of the winding W, and the end wire Wf is a fee end of the winding W.

### 1-4. First Bus Bar Unit

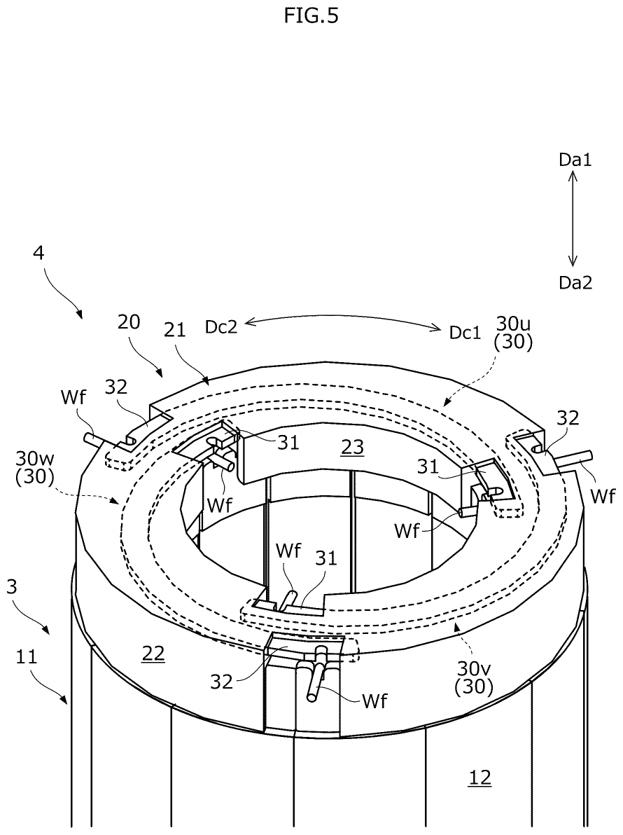

The first bus bar unit 4 is a component that is mounted on the first axial direction Da1 side of the stator 3 and connects the coils 16 of three phases on a phase by phase basis, and includes the resin holder 20 and the bus bars 30 as illustrated in FIG. 5. Each of the bus bars 30 is a conductive member that connects the coils 16 of the three phases on a phase by phase basis, and are extended along the circumferential direction and covered with (buried in) the holder 20. In other words, the first bus bar unit 4 is provided as an insert-molded product in which the bus bars 30 are assembled with the resin holder 20 or molded with the resin holder 20. Note that the expression “extending along” referred to in the embodiment is not limited to extending in a direction that agrees with (is parallel to) a reference direction (for example, the circumferential direction), and includes extending in a direction inclined with respect to the reference direction.

In the embodiment, the end wires Wf of the two phase-U coil groups 17u, the end wires Wf of the two phase-V coil groups 17v, and the end wires Wf of the two phase-W coil groups 17w are drawn out in the first axial direction Da1. Therefore, as illustrated in FIGS. 3 and 5, the first bus bar unit 4 is provided with three bus bars 30 including a phase-U bus bar 30u that connects the end wires Wf of the two phase-U coil groups 17u, a phase-V bus bar 30v that connects the end wires Wf of the two phase-V coil groups 17v, and a phase-W bus bar 30w that connects the end wires Wf of the two phase-W coil groups 17w.

For example, the three bus bars 30 are provided at the same position in the axial direction relative to the holder 20, that is, on the same plane without overlapping one another, as viewed in the axial direction as illustrated in FIG. 5. All the three bus bars 30 may have the same shape. Each of the bus bars 30 may be provided in such a manner that the first portion 31 on the first circumferential direction Dc1 side is located radially inward of the second portion 32 on the second circumferential direction Dc2 side. The three bus bars 30 have, for example, an extra-long plate shape extending in a spiral form in the circumferential direction, and are provided in such a manner as to be threefold rotational symmetric about the axis C. As illustrated in FIG. 3, the first portion 31 and the second portion 32 of each of the bus bars 30 are provided in such a manner as to overlap in the axial direction with the slots 15 from which the end wires Wf of two coil groups 17 of a phase connected by the bus bar 30 are drawn out, and are joined to these end wires Wf respectively.

As illustrated in FIG. 5, the first portion 31 of each of the bus bars 30 and the second portion 32 of any of the bus bars 30 other than the above bus bar 30 may be provided in such a manner as to overlap each other as viewed in the radial direction. To put another way, the first portion 31 of each of the bus bars 30 (for example, the phase-U bus bar 30u) may be provided in such a manner as to overlap with the second portion 32 of another bus bar 30 (for example, the phase-V bus bar 30v) that connects the coil group 17 (for example, the phase-V coil group 17v) of a phase different from the coil group 17 (for example, the phase-U coil group 17u) of a phase connected by the above bus bar 30 as viewed in the radial direction.

The end wires Wf of the coil groups 17 of different phases drawn from the same slot 15 (for example, the end wire Wf of the phase-U coil group 17u and the end wire Wf of the phase-V coil group 17v) are drawn (hooked) radially inward and radially outward respectively before the first bus bar unit 4 is mounted on the stator 3. The portion, which is drawn out in the first axial direction Da1, of each of the windings W forming its respective coil group 17 is the end wire Wf that is the free end as described above; therefore, the windings W can be easily hooked in this manner. Note that FIG. 5 illustrates a state in which the end wires Wf are drawn radially inward and outward.

After the first bus bar unit 4 is mounted on the stator 3, the end wire Wf drawn radially inward (for example, the end wire Wf of the phase-U coil group 17u) among the end wires Wf drawn from the same slot 15 is folded in the first axial direction Da1 and radially outward. The end wire Wf (for example, the end wire Wf of the phase-U coil group 17u) is thereafter joined by spot welding or soldering from the first axial direction Da1 side to the first portion 31 of the bus bar 30 (for example, the phase-U bus bar 30u) that is provided in such a manner that the slot 15 from which the end wire Wf is drawn out and the first portion 31 overlap each other.

Conversely, after the first bus bar unit 4 is mounted on the stator 3, the end wire Wf drawn radially outward (for example, the end wire Wf of the phase-V coil group 17v) among the end wires Wf drawn out from the same slot 15 is folded in the first axial direction Da1 and radially inward. The end wire Wf is thereafter joined by spot welding or soldering from the first axial direction Da1 side to the second portion 32 of the bus bar 30 (for example, the phase-V bus bar 30v) that is provided in such a manner that the slot 15 from which the end wire Wf is drawn out and the second portion 32 overlap each other.

Consequently, the end wires Wf of different phases drawn out from the common slot 15 can be joined to the bus bar 30 without crossing each other. Hence, it is encouraged to preventing contact (passage of electric current) between the end wires Wf, and it is possible to easily perform the joining process of the end wires Wf to the bus bars 30.

As described above, the holder 20 is a resin member that covers the bus bars 30, and is mounted on the stator 3. In the embodiment, the holder 20 has a circular ring shape. The holder 20 includes a main body portion 21 having a circular ring shape (doughnut shape) as viewed in the axial direction and a flat plate shape as viewed in the radial direction. The three bus bars 30 are covered with the main body portion 21. Note that as illustrated in FIG. 5, the main body portion 21 may be provided on the radially inner side with three notches that each expose a part of the first portion 31 of its respective one of the three bus bars 30. Moreover, the three notches that each expose a part of the second portion 32 of its respective one of the three bus bars 30 may be provided on the radially outer side.

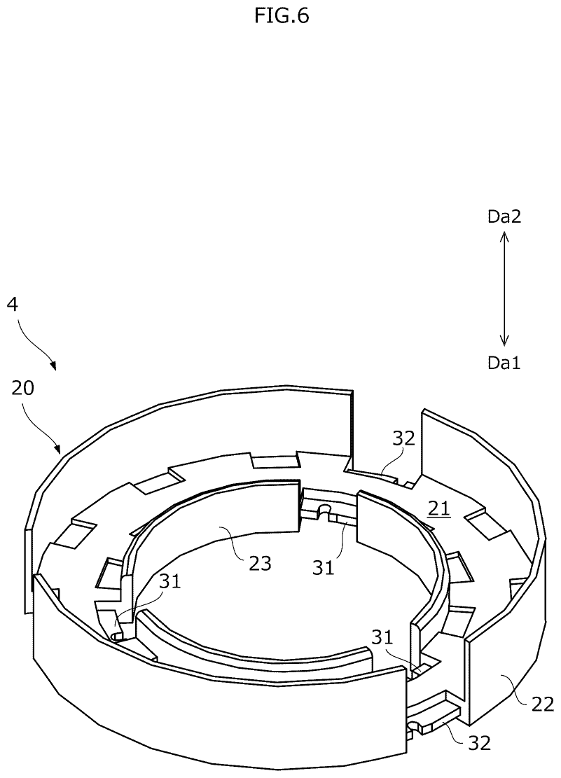

As illustrated in FIG. 6, the holder 20 may be further provided with outer wall portions 22 that stand in the second axial direction Da2 on an outer peripheral edge of the main body portion 21, and inner wall portions 23 that stand in the second axial direction Da2 on an inner peripheral edge of the main body portion 21. A plurality of grooves may be recessed into an end surface on the second axial direction Da2 side of the main body portion 21. The grooves, the outer wall portions 22, and the inner wall portions 23 can be used to temporarily position the split cores 11n if the core unit 11 includes the split cores 11n.

### 1-5. Second Bus Bar Unit

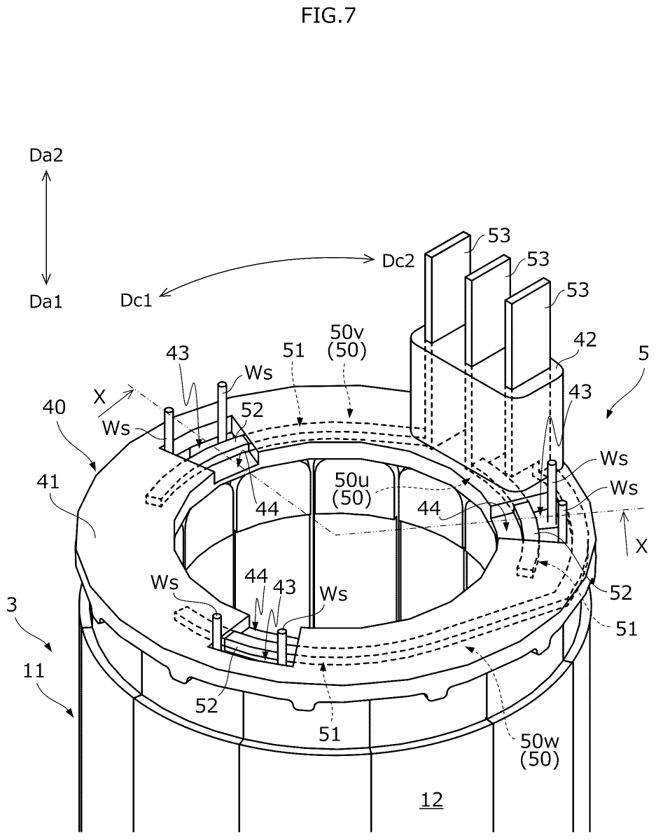

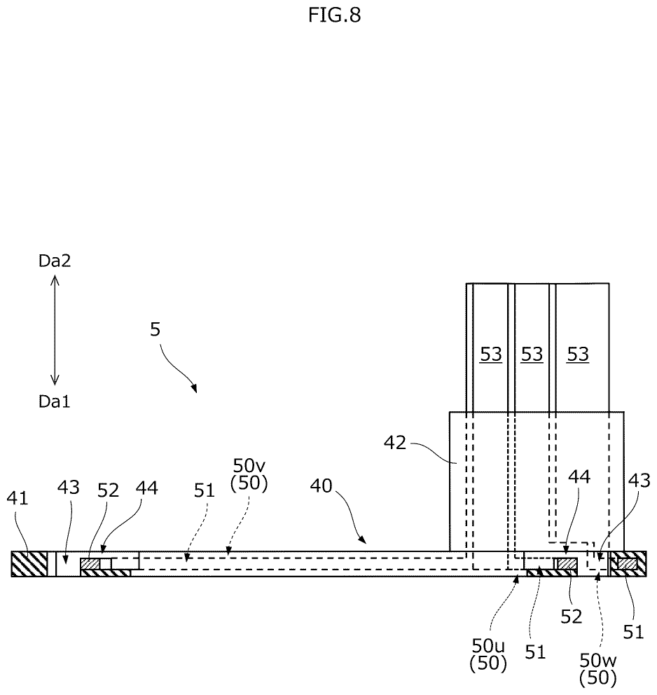

The second bus bar unit 5 is a component that connects the coils 16 of the three phases in a delta connection (delta connection), and includes a holder 40 and the bus bars 50 as illustrated in FIG. 7. The holder 40 is a non-conductive member, and is made of, for example, resin. As illustrated in FIGS. 7 and 8, each of the bus bars 50 is a conductive member including a base plate portion 51 that has a plate shape as viewed in the radial direction and has an approximately arc shape as viewed in the axial direction, and the base plate portions 51 are covered with (buried in) the holder 40. In other words, the second bus bar unit 5 is provided as an insert-molded product in which the bus bars 50 are assembled with the resin holder 40 or molded with the resin holder 40.

In the second bus bar unit 5, the holder 40 is mounted on the second axial direction Da2 side of the stator 3 in a state where one side (a first direction) of a thickness direction of the base plate portion 51 is aligned with the second axial direction Da2. The second bus bar unit 5 of the embodiment is mounted on the second axial direction Da2 side of the stator 3 in a state where the first direction of the thickness direction of the base plate portion 51 agrees with the second axial direction Da2. In other words, in the embodiment, the second axial direction Da2 corresponds to the “first direction” described in the claims, and the first axial direction Da1 corresponds to the “second direction” described in the claims.

In the embodiment, the bus bars 50 are provided to connect the coils 16 of two different phases among the coils 16 of the three phases. The start wires Ws of the two phase-U coil groups 17u, the start wires Ws of the two phase-V coil groups 17v, and the start wires Ws of the two phase-W coil groups 17w are drawn out toward the second axial direction Da2 side of the stator 3 of the embodiment. Correspondingly, the second bus bar unit 5 is provided with three bus bars 50 including a U-line bus bar 50u, a V-line bus bar 50v, and a W-line bus bar 50w.

As illustrated in FIG. 3, the U-line bus bar 50u connects the start wire Ws of one of the two phase-U coil groups 17u and the start wire Ws of one of the two phase-V coil groups 17v. The V-line bus bar 50v connects the start wire Ws of the other of the two phase-V coil groups 17v and the start wire Ws of one of the two phase-W coil groups 17w. The W-line bus bar 50w connects the start wire Ws of the other of the two phase-U coil groups 17u and the start wire Ws of the other of the two phase-W coil groups 17w.

Moreover, in the embodiment, each of the bus bars 50 is provided as a terminal that is electrically connected to an unillustrated external power feeding device. Therefore, each of the bus bars 50 further includes a terminal portion 53 that is connected to the external power feeding device.

Each of the base plate portions 51 has, for example, an approximately circular arc shape extending along the circumferential direction (that is, a direction orthogonal to the thickness direction). As illustrated in FIG. 8, the three base plate portions 51 are provided at the same position in the axial direction, and are provided in such a manner as not to overlap one another as viewed in the axial direction, that is, provided on the same plane.

The start wire Ws of each of the coil groups 17 is joined to a part of the base plate portion 51. Hereinafter, a portion, to which the start wire Ws is joined, of the base plate portion 51 of each of the bus bars 50 is referred to as a joint portion 52. As illustrated in FIG. 3, each of the U-line bus bar 50u, the V-line bus bar 50v, and the W-line bus bar 50w may connect the start wires Ws of the coil groups 17 of different phases, the start wires Ws being drawn out from the common slot 15. Correspondingly, the joint portion 52 of each of the bus bars 50 may be provided in such a manner as to overlap in the axial direction with the slot 15 from which the start wires Ws connected by the bus bar 50 are drawn out.

In the embodiment, the start wires Ws of the coil groups 17 are drawn out from the three slots 15 being every fourth slot located in the circumferential direction as described above. Therefore, each of the bus bars 50 is provided with one joint portion 52, and as illustrated in FIG. 7, and three joint portions 52 are equally spaced apart from one another in the circumferential direction in such a manner as to overlap with the three slots 15 respectively. For example, the three joint portions 52 may be placed in such a manner as to be located radially inward of the start wires Ws with the second bus bar unit 5 mounted on the stator 3. The positions of the three joint portions 52 in the radial direction are set at substantially the same position. Note that FIG. 7 illustrates a state in which the start wires Ws are drawn out in the second axial direction Da2.

Each of the terminal portions 53 has, for example, a flat plate shape that stands in the second axial direction Da2 on an end portion of the base plate portion 51 in its extension direction. For example, as illustrated in FIG. 7, the three terminal portions 53 may be gathered in one place in the circumferential direction and spaced apart from one another. In the embodiment, the three terminal portions 53 are gathered between the joint portion 52 of the U-line bus bar 50u and the joint portion 52 of the V-line bus bar 50v.

The base plate portion 51 of the U-line bus bar 50u of which the joint portion 52 is located on the second circumferential direction Dc2 side of the gathering place of the three terminal portions 53 is extended in such a manner as to agree with the circumferential direction, and an end portion thereof on the first circumferential direction Dc1 side is continuously provided with the terminal portion 53. Moreover, the base plate portion 51 of the V-line bus bar 50v of which the joint portion 52 is located on the first circumferential direction Dc1 side of the gathering place of the three terminal portions 53 is extended in such a manner as to agree with the circumferential direction, and an end portion thereof on the second circumferential direction Dc2 side is continuously provided with the terminal portion 53.

On the other hand, the base plate portion 51 of the W-line bus bar 50w of which the joint portion 52 is located at a position relatively away from the gathering place of the three terminal portions 53 is extended in such a manner as to agree with the circumferential direction around the joint portion 52, but is extended in such a manner as to gradually go further radially outward toward the first circumferential direction Dc1 side (as it goes further away from the joint portion 52 and nearer the terminal portion 53). The base plate portion 51 of the W-line bus bar 50w is placed radially outward of the base plate portion 51 of the U-line bus bar 50u on the first circumferential direction Dc1 side of the base plate portion 51 of the W-line bus bar 50w in such a manner as not to interfere with the base plate portion 51 of the U-line bus bar 50u. Specifically, the base plate portion 51 of the W-line bus bar 50w is aligned in the radial direction with the base plate portion 51 of the U-line bus bar 50u across the start wires Ws that are connected to the U-line bus bar 50u. An end portion on the first circumferential direction Dc1 side of the base plate portion 51 of the W-line bus bar 50w is continuously provided with the terminal portion 53.

The base plate portions 51 of the U-line bus bar 50u, the V-line bus bar 50v, and the W-line bus bar 50w are arranged as described above, so that it is possible to place these base plate portions 51 at the same position in the axial direction, that is, on the same plane without overlapping in the axial direction.

As described above, the holder 40 is a resin member that covers the base plate portions 51 of the bus bars 50, and is mounted on the stator 3. The holder 40 of the embodiment includes a main body portion 41 and a protruding portion 42.

The main body portion 41 is a portion for covering the base plate portions 51 of the bus bars 50, and has, for example, a circular ring shape (doughnut shape) as viewed in the axial direction and a flat plate shape as viewed in the radial direction. The main body portion 41 is provided with exposure portions 44 that expose only the joint portions 52 of the base plate portions 51 and guide portions 43 that guide the start wires Ws to be joined to the joint portions 52, as a part of the configuration that encourages a reduction in the number of man-hours related to the assembly of the second bus bar unit 5 to the stator 3 and the joining of the start wires Ws (conductive wires) to the bus bars 50.

In the embodiment, as illustrated in FIG. 8, the guide portions 43 are provided as through-holes penetrating the main body portion 41 in the axial direction. Hereinafter, the guide portions 43 are also referred to as the through-holes 43. When the second bus bar unit 5 is mounted on the stator 3, the start wires Ws are inserted through the through-holes 43 from the first axial direction Da1 to the second axial direction Da2. Therefore, the guide portions 43 can also be said to be portions that guide the start wires Ws from the first axial direction Da1 to the second axial direction Da2.

The through-holes 43 are provided at positions overlapping the start wires Ws in the axial direction, that is, at positions overlapping the slots 15 from which the start wires Ws are drawn out. In the embodiment, the start wires Ws are drawn out from three places in the circumferential direction (the three slots 15 being every fourth slot located in the circumferential direction); therefore, three through-holes 43 are provided. As described above, the joint portion 52 of each of the bus bars 50 is provided at a position overlapping in the axial direction with the common slot 15 from which the start wires Ws connected by the bus bar 50 are drawn out. Therefore, to put another way, the three through-holes 43 are provided at the same positions in the circumferential direction as the joint portions 52 of the three bus bars 50, respectively.

The start wires Ws of the coil groups 17 of different phases connected by each of the bus bars 50 are drawn out from the common slot 15, and are inserted through the common through-hole 43 as illustrated in FIG. 7 and are joined to the joint portion 52 of the bus bar 50. To put another way, the start wires Ws of the coil groups 17 of different phases connected by each of the bus bars 50 are drawn out from the common slot 15 in such a manner as to be adjacent to each other in the circumferential direction. As a result, two start wires Ws can be drawn out from the common (one) through-hole 43.

Moreover, a portion, which is drawn out in the second axial direction Da2, of each of the windings W forming its respective coil group 17 is the start wire Ws that is the fixed end. As described above, the start wires Ws have the characteristic that the positions of the start wires Ws are less likely to vary among the coil groups 17; therefore, the start wires Ws can be inserted through the through-holes 43 simply by mounting the second bus bar unit 5 on the stator 3. This eliminates the need for a process of adjusting the positions of the start wires Ws and a process of locking the start wires Ws somewhere, which encourages a reduction in the number of man-hours related to the assembly of the second bus bar unit 5 to the stator 3. Moreover, the start wires Ws can be drawn out at positions suitable for joining to the joint portions 52, that is, at positions passing through the through-holes 43, with high reproducibility.

Each of the exposure portions 44 is a portion that exposes only the joint portion 52 of the base plate portion 51 covered with the main body portion 41, and is provided around the guide portion 43. In other words, it can be said that the guide portions 43 are attached to the exposure portions 44. Three exposure portions 44 are provided corresponding to the number of the guide portions 43.

Each of the exposure portions 44 may be formed, for example, by lightening a part of the main body portion 41. In the embodiment, each of the exposure portions 44 is provided as a notch obtained by cutting out (lightening) a portion, which is on the radially inner or outer side of the through-hole 43, of the main body portion 41 (a part of the main body portion 41) from the second axial direction Da2 side. Such exposure portions 44 expose the joint portions 52 of the base plate portions 51 in the second axial direction Da2. Hereinafter, the exposure portions 44 are also referred to as the notches 44.

In the embodiment, as described above, the joint portions 52 are placed in such a manner as to be located radially inward of the start wires Ws; therefore, the notches 44 are provided adjacent to the radially inner sides of the through-holes 43. For example, as illustrated in FIGS. 7 and 8, each of the notches 44 may be provided by cutting out the entire region of a portion on the radially inner side of the through-hole 43 from the main body portion 41. Moreover, each of the notches 44 may be provided in such a manner as to retain a portion, which is on the radially inner side of the joint portion 52, of the main body portion 41 without cutting out the entire region.

For example, as illustrated in FIGS. 7 and 8, each of the notches 44 may be provided in such a manner as to expose not only a surface, which faces in the second axial direction Da2, of the joint portion 52 but also a side surface, which faces in the radial direction, of the joint portion 52, or may be provided in such a manner as to expose only the surface, which faces in the second axial direction Da2, of the joint portion 52. Note that the notches 44 may be provided in such a manner as to penetrate the main body portion 41 in the axial direction. In this case, there is no clear boundary between each of the through-holes 43 and its respective notch 44, and the through-holes 43 are expanded by the notches 44.

The start wires Ws inserted through the through-holes 43 are bent radially inward and guided into spaces formed by the notches 44 (spaces obtained by partly lighting the main body portion 41). In this manner, the guide portions 43 guide the start wires Ws to the exposure portions 44 to be bent, which means that the guide portions 43 are portions that guide the start wires Ws to the exposure portions 44 to be bent. Moreover, the start wires Ws are folded not radially outward but radially inward, which prevents a leakage of current from the start wires Ws to the housing 6.

Thereafter, the start wires Ws come into contact with the joint portions 52 exposed in the second axial direction Da2 by the notches 44 from the second axial direction Da2 side. The start wires Ws in contact with the joint portions 52 are joined to the joint portions 52 not by conventional manual soldering but by spot welding in which the joint portions 52 and the start wires Ws are pressurized from the second axial direction Da2 side and melt-bonded together. Therefore, it is encouraged to reduce the number of man-hours related to the joining of the start wires Ws to the bus bars 50.

The joint portions 52 that are pressurized in the first axial direction Da1 at the time of spot welding are supported by the base plate portions 51 covered with the main body portion 41 of the holder 40 that is mounted on the stator 3. Hence, the joint portions 52 are prevented from moving in the first axial direction Da1, or the bus bars 50 are prevented from falling out, during spot welding. Note that a portion, which is located on the first axial direction Da1 side relative to the notches 44, of the main body portion 41 can also have a function of supporting the joint portions 52 from the first axial direction Da1 side at the time of spot welding between the joint portions 52 and the start wires Ws.

To put another way, in the embodiment, the base plate portions 51 are covered with the holder 40 that is mounted on the stator 3, and the notches 44 (the exposure portions 44) are provided which expose the joint portions 52 of the base plate portions 51 in the second axial direction Da2. Therefore, the joint portions 52 and the start wires Ws can be joined not by conventional manual soldering but by spot welding. Moreover, the portion, which is joined to the joint portion 52, of the winding W of each of the coil groups 17 is the start wire Ws in which variations are less likely to occur at the drawing position, and these start wires Ws are always drawn out from the through-holes 43. Therefore, the reproducibility of the positions of the start wires Ws to be spot-welded is improved. Hence, when the joining process of the start wires Ws is automated and incorporated into a manufacturing process of the motor 1, it is possible to prevent a handling operation of the start wires Ws from becoming complicated.

In the embodiment, as illustrated in FIG. 7, the joint portion 52 of each of the bus bars 50 is provided at a position excluding both end portions of the approximately circular arc-shaped base plate portion 51 in its extension direction. Moreover, each of the notches 44 is provided in such a manner that only the joint portion 52 of the base plate portion 51 is exposed and portions adjacent to both sides of the joint portion 52 of the base plate portion 51 in the extension direction are not exposed from the main body portion 41. To put another way, in terms of each of the base plate portions 51, only the joint portion 52 is exposed in the second axial direction Da2, and the portions adjacent to both sides of the joint portion 52 are covered with the holder 40 without being exposed. Consequently, forces that hold the bus bars 50 at the time of spot welding of the joint portions 52 and the start wires Ws increase, which prevents the pullout.

The protruding portion 42 is a portion for covering (burying) a portion on the first axial direction Da1 side of the terminal portion 53 of each of the bus bars 50. For example, the protruding portion 42 is provided in the circumferential direction of the main body portion 41, protruding in the second axial direction Da2 from the gathering place of the three terminal portions 53.

### 2. Operations and Effects

(1) In the above-mentioned second bus bar unit 5, the holder 40 that covers the base plate portions 51 of the bus bars 50 is provided with the exposure portions 44 and the guide portions 43. The conductive wires (the start wires Ws) that are joined to each of the joint portions 52 being a part of its respective base plate portion 51 are guided by the guide portions 43 to the exposure portion 44 to be bent, and come into contact with the joint portion 52 exposed by the exposure portion 44. Consequently, the conductive wires can be joined to the joint portion 52 not by conventional manual soldering but by spot welding; therefore, it is possible to reduce the number of man-hours related to the joining of the conductive wires.

(2) Moreover, if each of the exposure portions 44 is formed by lightening a part of the main body portion 41 of the holder 40, the conductive wires can be placed in the space crated by lightening. Therefore, it is possible to prevent the conductive wires from coming into contact with other components (for example, the end bell 7 placed on the second axial direction Da2 side of the second bus bar unit 5).

(3) In the above-mentioned second bus bar unit 5 and motor 1, the holder 40 covers the base plate portions 51 of the bus bars 50, and is provided with the exposure portions 44 that expose only the joint portions 52 of the base plate portions 51 in the first direction (here, the second axial direction Da2) of the thickness direction of the base plate portions 51, and the guide portions 43 that guide the conductive wires (the start wires Ws) from the second direction (here, the first axial direction Da1) of the thickness direction to the first direction. Consequently, the conductive wires guided by the guide portions 43 from the second direction to the first direction are brought into contact with the joint portions 52 exposed by the exposure portions 44 attached to the guide portions 43 from the first direction side, and the conductive wires and the joint portions 52 can be joined by spot welding. Therefore, it is possible to reduce the number of man-hours related to the joining of the conductive wires as compared to conventional manual solder bonding.

(4) If the base plate portions 51 of the bus bars 50 provided to the second bus bar unit 5 are placed in such a manner as to be located on the same plane, it is possible to reduce the axial thickness of the portion, which covers the base plate portions 51, of the holder 40 of the second bus bar unit 5, that is, the main body portion 41. This makes it possible to achieve a reduction in the thickness of the second bus bar unit 5 and by extension to contribute to a reduction in the size of a device (here, the motor 1) to which the second bus bar unit 5 is applied.

(5) If each of the joint portions 52 is provided at the position excluding both end portions of the base plate portion 51 in the extension direction and is covered with the holder 40 without exposing the portions adjacent to both sides of the joint portion 52 in the extension direction of the base plate portion 51, the joint portion 52 is in a state of being supported at both ends. Therefore, the forces that hold the bus bars 50 at the time of spot welding increase, which prevents the bus bars 50 from falling out, so that the conductive wires can be more appropriately joined to the joint portions 52.

(6) In the above-mentioned motor 1, the start wires Ws of the windings W forming the coils 16 (the coil groups 17) of the stator 3 are all drawn out from the second axial direction Da2 side. Moreover, in the second bus bar unit 5, the holder 40 is mounted on the second axial direction Da2 side of the stator 3. The guide portions 43 are provided as the through-holes that penetrate in the axial direction and through which the start wires Ws of the coils 16 (the coil groups 17) are inserted, and the exposure portions 44 are provided on the radially inner sides of the through-holes 43, as the notches that expose the joint portions 52 of the base plate portions 51 in the second axial direction Da2.

Such a configuration enables the assembly of the second bus bar unit 5 to the stator 3 to be completed simply by mounting the holder 40 on the stator 3 while drawing the start wires Ws through the through-holes 43, so that it is possible to reduce the number of man-hours for the assembly. Moreover, the portion, which is joined to the bus bar 50 of the second bus bar unit 5, of each of the windings W forming its respective coil 16 (coil group 17), is the start wire Ws in which variations are less likely to occur at the position. Therefore, when the holder 40 is mounted on the stator 3, the start wires Ws can be easily drawn through the through-holes 43. Therefore, it is also possible to reduce the number of man-hours for the assembly in this respect.

Furthermore, the joint portions 52 of the base plate portions 51 covered with the holder 40 that is mounted on the stator 3 are exposed in the second axial direction Da2 by the notches 44; therefore, the start wires Ws inserted through the through-holes 43 and the joint portions 52 can be joined by spot welding from the second axial direction Da2 side where the stator 3 is not present. Therefore, it is possible to reduce the number of man-hours related to the connection process of the start wires Ws as compared to conventional manual solder bonding. Moreover, the start wires Ws can be joined not by soldering, which requires manual operations, but by spot welding; therefore, the joining process of the start wires Ws can be automated and incorporated into the manufacturing process of the motor 1.

(7) In the above-mentioned second bus bar unit 5, the notches 44 are provided on the radially inner sides of the through-holes 43. Consequently, the start wires Ws inserted through the through-holes 43 can be folded not radially outward but radially inward, and can be brought into contact with the joint portions 52; therefore, it is possible to prevent a leakage of current from the start wires Ws to the housing 6.

(8) If the start wires Ws of the coils 16 (the coil groups 17) of two different phases that are connected by each of the bus bars 50 of the second bus bar unit 5 are drawn out from the same slot 15 in such a manner as to be adjacent to each other in the circumferential direction, these start wires Ws can be inserted together through one through-hole 43 and joined to the joint portion 52 by spot welding at a time. Hence, it is possible to further reduce the number of man-hours for the assembly.

### 3. Others

The above-mentioned configurations of the second bus bar unit 5 and the motor 1 are examples, and their configurations are not limited to the above-mentioned ones. For example, in the motor 1, the second bus bar unit 5, the stator 3, and the first bus bar unit 4 may be placed in this order from the first axial direction Da1 to the second axial direction Da2. In this case, the “first direction” and the “predetermined axial direction” described in the claims are the first axial direction Da1, and the “second direction” described in the claims is the second axial direction Da2. Note that the motor 1 may not include the first bus bar unit 4.

The second bus bar unit 5 may not be an insert-molded product in which the bus bars 50 are molded with the resin holder 40, but may be a structure in which the bus bars 50 are assembled (assembled) to the inside of the holder 40 after the resin holder 40 is molded. Similarly, the first bus bar unit 4 may not be an insert-molded product, but may be a structure in which the bus bars 30 are assembled (assembled) to the inside of the holder 20 after the resin holder 20 is molded. Note that the end wires Wf may be joined by soldering to the bus bars 30 of the first bus bar unit 4.

Each of the windings W provided to the stator 3 may not form two coils 16 of the same phase placed adjacent to each other, and may form, for example, a single coil 16 or may continuously form four coils 16 of the same phase. In other words, the number of the windings W provided to the stator 3 is not limited to six as described above. The start wires Ws of the windings W forming the coils 16 of different phases adjacent to each other in the circumferential direction may not be drawn out from the same slot 15. The number of the coils 16 provided to the stator 3 may not be 12.

Each of the bus bars 50 of the second bus bar unit 5 may not be a terminal that is electrically connected to an external power feeding device, and may be a mere bus bar (conductor) that electrically connects a terminal that is electrically connected to the external power feeding device and each of the coils 16 (each of the coil groups 17). In this case, the base plate portions 51 of the U-line bus bar 50u, the V-line bus bar 50v, and the W-line bus bar 50w may be extended only around the joint portions 52 in such a manner as not to overlap one another in the circumferential direction.

Each of the base plate portions 51 as the “base plate portion” according to claim 1 of the claims is simply required to have at least an approximately arc shape and may not have a plate shape. Moreover, each of the base plate portions 51 as the “base plate portion” according to claim 3 of the claims is simply required to have at least a plate shape and may not have an approximately arc shape. Each of the joint portions 52 may be provided at an end portion of the plate-shaped base plate portion 51 in the extension direction.

The holder 40 of the second bus bar unit 5 is simply required to have at least a shape that can cover the base plate portions 51, and may not have a circular ring shape. The holder 40 of the second bus bar unit 5 may have, for example, a circular arc shape, a disc shape, a fan shape, or a rectangular shape, and the main body portion 41 of the holder 40 may not have a plate shape as viewed in the radial direction.

Each of the notches 44 provided to the holder 40 of the second bus bar unit 5 may be provided on the radially outer side of its respective through-hole 43. Not all the joint portions 52 of the three bus bars 50 provided to the second bus bar unit 5 are provided with the through-hole 43 and the notch 44, but only the joint portion 52 of one of the three bus bars 50 may be provided with the through-hole 43 and the notch 44. If two start wires Ws that are connected by each of the bus bars 50 of the second bus bar unit 5 are drawn out at positions relatively apart from each other in the circumferential direction, the through-holes 43 and the notches 44 may be provided which join the start wires Ws to the base plate portion 51, respectively. In other words, each of the through-holes 43 may not be a hole through which two start wires Ws are drawn out together, and a plurality of the through-holes 43 and a plurality of the notches 44 may be provided to the base plate portion 51 of one bus bar 50.

Each of the exposure portions 44 is simply required to be at least a portion that exposes only the joint portion 52 of the base plate portion 51, and may not be a notch obtained by notching the main body portion 41 from the first direction side (the second axial direction Da2 side). Each of the guide portions 43 may not be a through-hole that penetrates the main body portion 41 in the axial direction. Each of the guide portions 43 may be, for example, a notch obtained by notching the main body portion 41 from the radially outer side in such a manner as to penetrate the main body portion 41 in the axial direction.

The bus bar unit provided with the guide portions 43 and the exposure portions 44 may not be the second bus bar unit 5 that connects the coils 16 (the coil groups 17) of two different phases among the coils 16 (the coil groups 17) of the three phases, but may be the first bus bar unit 4 that connects the coils 16 (the coil groups 17) of the three phases on a phase by phase basis. The end wires Wf of the windings W may be joined to the bus bar unit. The bus bar unit is simply required to be at least one to which a conductive wire is joined, and the conductive wire may not be the winding W provided to the stator 3.

If the bus bar unit is provided with a plurality of bus bars, the plate-shaped base plate portions of the bus bars may partly overlap in the thickness direction. Moreover, the bus bar unit may not include a plurality of bus bars.

### DESCRIPTION OF REFERENCE SIGNS

1 Motor (brushless motor)
1s Shaft
2 Rotor
3 Stator
5 Second bus bar unit (bus bar unit)
15 Slot
16 Coil
16u Phase-U coil (coil)
16v Phase-V coil (coil)
16w Phase-W coil (coil)
17 Coil group (coils)
17u Phase-U coil group (coils)
17v Phase-V coil group (coil)
17w Phase-W coil group (coil)
40 Holder
41 Main body portion
43 Through-hole (guide portion)
44 Notch (exposure portion)
50 Bus bar
50u U-line bus bar (bus bar)
50v V-line bus bar (bus bar)
50w W-line bus bar (bus bar)
51 Base plate portion
52 Joint portion (part of the base plate portion)
Da1 First axial direction (second direction)
Da2 Second axial direction (first direction, predetermined axial direction)
W Winding (conductive wire)
Ws Start wire (conductive wire)

1. (canceled)

2. (canceled)

3. A bus bar unit comprising:
a conductive bus bar including a plate-shaped base plate portion; and
a resin holder configured to cover the base plate portion, wherein
the holder includes:
an exposure portion that exposes only a part of the base plate portion in a first direction of a thickness direction of the base plate portion; and
a guide portion that is attached to the exposure portion and guides a conductive wire to be joined to the part from a second direction opposite to the first direction to the first direction,
the part is provided at a position excluding both end portions of the base plate portion in an extension direction thereof, and
portions, which are adjacent to both sides of the part in the extension direction, of the base plate portion are covered with the holder without being exposed.

4. The bus bar unit according to claim 3, wherein
the bus bar comprises a plurality of the bus bars; and
the base plate portions of the plurality of the bus bars are located on a same plane.

5. (canceled)

6. The bus bar unit according to claim 3, wherein
the bus bar unit is applied to an inner rotor brushless motor including a ring-shaped stator and a rotor located on a radially inner side of the stator,
the conductive wire is a start wire of a winding forming a coil of the stator, and is drawn out in a predetermined axial direction of an axial direction of the stator,
in a state where the first direction is aligned with the predetermined axial direction,
the holder is mounted on the predetermined axial direction side of the stator,
the guide portion is a through-hole that penetrates in the axial direction and through which the start wire is inserted, and
the exposure portion is a notch that exposes the part of the base plate portion in the predetermined axial direction on the inner side or a radially outer side of the through-hole.

7. The bus bar unit according to claim 6, wherein the notch is provided on the inner side of the through-hole.

8. A brushless motor comprising:
the bus bar unit according to claim 6;
the stator on which the bus bar unit is mounted; and
the rotor configured to rotate integrally with a shaft on the inner side of the stator.

9. The brushless motor according to claim 8, wherein
the stator is provided with coils of three phases,
the bus bar is a terminal that connects coils of two different phases among the coils of the three phases and is electrically connected to an external power feeding device, and comprises a plurality of the bus bars,
the holder includes the through-holes and the notches as many as the bus bars, and
the start wires of the windings forming the coils of the two different phases connected by each of the bus bars are drawn out from the same slot in the predetermined axial direction, inserted through the common through-hole, and joined to the part of the bus bar.

10. A bus bar unit applied to an inner rotor brushless motor including a ring-shaped stator and a rotor located on a radially inner side of the stator, the bus bar unit comprising:
a conductive bus bar including a plate-shaped base plate portion; and
a resin holder configured to cover the base plate portion, wherein
the holder includes:
an exposure portion that exposes only a part of the base plate portion in a first direction of a thickness direction of the base plate portion; and
a guide portion that is attached to the exposure portion and guides a conductive wire to be joined to the part from a second direction opposite to the first direction to the first direction,
the conductive wire is a start wire of a winding forming a coil of the stator, and is drawn out in a predetermined axial direction of an axial direction of the stator,
in a state where the first direction is aligned with the predetermined axial direction,
the holder is mounted on the predetermined axial direction side of the stator,
the guide portion is a through-hole that penetrates in the axial direction and through which the start wire is inserted, and
the exposure portion is a notch that exposes the part of the base plate portion in the predetermined axial direction on the inner side or a radially outer side of the through-hole, and
the notch is provided on the inner side of the through-hole.

11. The bus bar unit according to claim 10, wherein
the bus bar comprises a plurality of the bus bars; and
the base plate portions of the plurality of the bus bars are located on a same plane.

12. A brushless motor comprising:
the bus bar unit according to claim 10;
the stator on which the bus bar unit is mounted; and
the rotor configured to rotate integrally with a shaft on the inner side of the stator.

13. The brushless motor according to claim 12, wherein
the stator is provided with coils of three phases,
the bus bar is a terminal that connects coils of two different phases among the coils of the three phases and is electrically connected to an external power feeding device, and comprises a plurality of the bus bars,
the holder includes the through-holes and the notches as many as the bus bars, and
the start wires of the windings forming the coils of the two different phases connected by each of the bus bars are drawn out from the same slot in the predetermined axial direction, inserted through the common through-hole, and joined to the part of the bus bar.

14. A brushless motor of an inner rotor type, the brushless motor comprising:
a bus bar unit;
a ring-shaped stator on which the bus bar unit is mounted; and
a rotor located on a radially inner side of the stator and configured to rotate integrally with a shaft on the inner side of the stator, wherein
the bus bar unit includes:
a conductive bus bar including a plate-shaped base plate portion; and
a resin holder configured to cover the base plate portion,
the holder includes:
an exposure portion that exposes only a part of the base plate portion in a first direction of a thickness direction of the base plate portion; and
a guide portion that is attached to the exposure portion and guides a conductive wire to be joined to the part from a second direction opposite to the first direction to the first direction,
the conductive wire is a start wire of a winding forming a coil of the stator, and is drawn out in a predetermined axial direction of an axial direction of the stator,
in a state where the first direction is aligned with the predetermined axial direction,
the holder is mounted on the predetermined axial direction side of the stator,
the guide portion is a through-hole that penetrates in the axial direction and through which the start wire is inserted, and
the exposure portion is a notch that exposes the part of the base plate portion in the predetermined axial direction on the inner side or a radially outer side of the through-hole,
the stator is provided with coils of three phases,
the bus bar is a terminal that connects coils of two different phases among the coils of the three phases and is electrically connected to an external power feeding device, and comprises a plurality of the bus bars,
the holder includes the through-holes and the notches as many as the bus bars, and
the start wires of the windings forming the coils of the two different phases connected by each of the bus bars are drawn out from the same slot in the predetermined axial direction, inserted through the common through-hole, and joined to the part of the bus bar.

15. The brushless motor according to claim 14, wherein the base plate portions of the plurality of the bus bars are located on a same plane.
